(19) United States
(12) Patent Application Publication
(10) Pub. No.: US 2004/0064247 A1
(43) Pub. Date: Apr. 1, 2004

(54) Method and system for remotely managing vehicle mileage

(76) Inventor: Christopher E. Davis, Plano, TX (US)

Correspondence Address: BAKER BOTTS L.L.P., 2001 ROSS AVENUE, SUITE 600, DALLAS, TX, 75201-2980, US

(21) Appl. No.: 10/259,178

(22) Filed: Sep. 26, 2002

(51) Int. Cl. G06F 19/00

(52) U.S. Cl. 701/201; 340/466

(57) ABSTRACT

According to one embodiment of the invention, a method for remotely managing vehicle mileage includes receiving a signal from a computer on a vehicle over a wireless communications network and storing the mileage reading. The signal is indicative of a mileage reading for the vehicle. The mileage reading may be indicative of an odometer reading of the vehicle or a trip meter reading of the vehicle. The method may further include sending mileage information for the vehicle to a client, in which the mileage information is related to the stored mileage reading.

### BACKGROUND OF THE INVENTION

Keeping track of the mileage that a vehicle travels is important in many instances. For example, a state government may be interested in knowing how many miles were driven in their state by a particular vehicle so the government can accurately impose a road use tax. Such was the subject of U.S. Pat. No. 5,359,528 (“the '528 Patent”) issued to Haendel et al. In this patent, vehicle mileage is read automatically by an onboard computer and stored therein. The mileage information captured may then be downloaded at a later time by a state government for taxing purposes.

Vehicle mileage may also be important in business contexts, such as billing clients for traveling expenses. Such was the subject of U.S. Pat. No. 5,579,242 (“the '242 Patent”) issued to Fisher. In this patent, similar to the '528 Patent, an onboard computer records vehicle mileage information on magnetic media for later transference to a database for billing purposes.

Vehicle mileage may also be important in other contexts, such as leasing of a vehicle. In a typical lease, only a certain amount of miles are allowed to be driven by the lessee before additional costs are charged to the lessee. A car dealer may also be interested in vehicle mileage because warranty information and scheduled maintenance is typically based on total vehicle miles driven.

### SUMMARY OF THE INVENTION

According to one embodiment of the invention, a method for remotely managing vehicle mileage includes receiving a signal from a computer on a vehicle over a wireless communications network and storing the mileage reading. The signal is indicative of a mileage reading for the vehicle. The mileage reading may be indicative of an odometer reading of the vehicle or a trip meter reading of the vehicle. The method may further include sending mileage information for the vehicle to a client, in which the mileage information is related to the stored mileage reading.

Embodiments of the invention provide a number of technical advantages. Embodiments of the invention may include all, some, or none of these advantages. For example, having the ability to accurately capture and store vehicle mileage periodically may allow businesses to increase the efficiency of their billing procedures, which would lead to better service to customers and increased profitability. For example, an insurance company or leasing company may be able to bill on a per-mile-driven basis. Governments may also benefit from this by being able to accurately tax vehicle owners for road use or to bill auto owners for registration on a per-mile-driven basis. Manufacturers and/or automobile dealers are typically interested in accurate vehicle mileage recordings for reasons such as warranty coverage, scheduled maintenance, sales, and leasing. Another technical advantage of one embodiment of the invention is that car owners have no involvement in the capturing of vehicle mileage, which takes away any burden on the owners.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIG. 1 is a schematic diagram illustrating a system for remotely managing vehicle mileage according to one embodiment of the present invention;

FIG. 2 is a block diagram illustrating a system for capturing and storing vehicle mileage in accordance with one embodiment of the present invention;

FIG. 3 is a block diagram illustrating a system for utilizing stored vehicle mileage in accordance with one embodiment of the present invention;

FIG. 4 is a block diagram of a computer for use in carrying out one embodiment of the systems of FIGS. 2 and 3; and

FIG. 5 is a flowchart illustrating a method of capturing, storing, and utilizing vehicle mileage in accordance with one embodiment of the present invention.

### DETAILED DESCRIPTION OF EXAMPLE EMBODIMENTS OF THE INVENTION

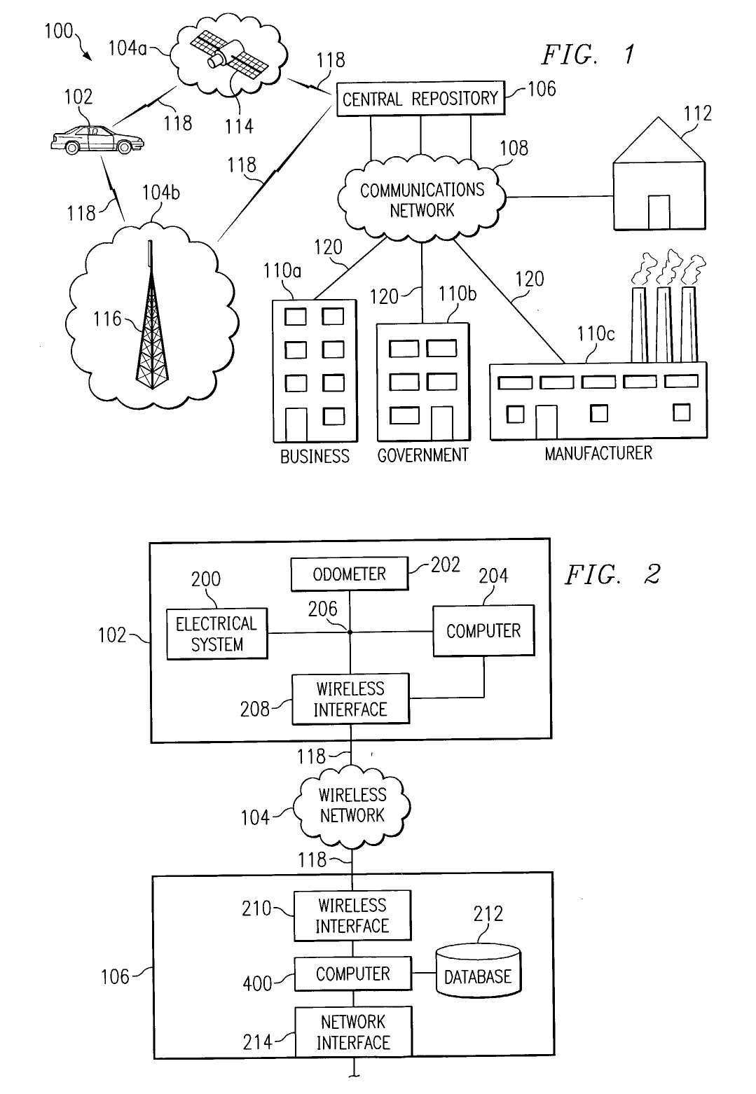

Example embodiments of the present invention and their advantages are best understood by referring now to FIGS. 1 through 5 of the drawings, in which like numerals refer to like parts.

FIG. 1 is a schematic diagram illustrating a system 100 for remotely managing vehicle mileage according to one embodiment of the present invention. In the illustrated embodiment, system 100 includes a vehicle 102, a wireless network 104, a central repository 106, a communications network 108, a plurality of entities 110, and a consumer 112. Generally, mileage of vehicle 102 at any given point in time is wirelessly transmitted to central repository 106 and stored therein. Based on stored mileage readings of vehicle 102, mileage information for vehicle 102 may then be transmitted to entities 110 so that entities 110 may utilize the mileage information according to their respective needs, as described in more detail below. In another embodiment, central repository 106 and an entity 110 are one and the same; thus, mileage information for vehicle 102 may be sent directly from central repository 106 to consumer 112, with or without the use of communications network 108.

Although illustrated in FIG. 1 as an automobile, vehicle 102 may be other suitable vehicles, such as a truck, a motorcycle, a boat, an aircraft, a snowmobile, or any other suitable moving object that includes a mileage recording device to keep track of how many miles that the object travels. As described further below in conjunction with FIG. 2, vehicle 102 includes particular functionality that allows its mileage recording device to be read and transmitted to central repository 106 via wireless network 104.

Wireless network 104 may be any suitable wireless communications network operable to transmit signals representing mileage information for vehicle 102 to central repository 106. For example, a satellite-based wireless network 104a having one or more satellites 114 and other suitable hardware and/or software may be utilized or a terrestrial-based wireless network 104b having one or more base stations 116 and other suitable hardware and/or software may be utilized. Wireless network 104 is coupled to vehicle 102 and central repository 106 with one or more wireless links 118. Wireless links 118 are radio frequency (RF) links that may be based on any suitably established technologies or standards.

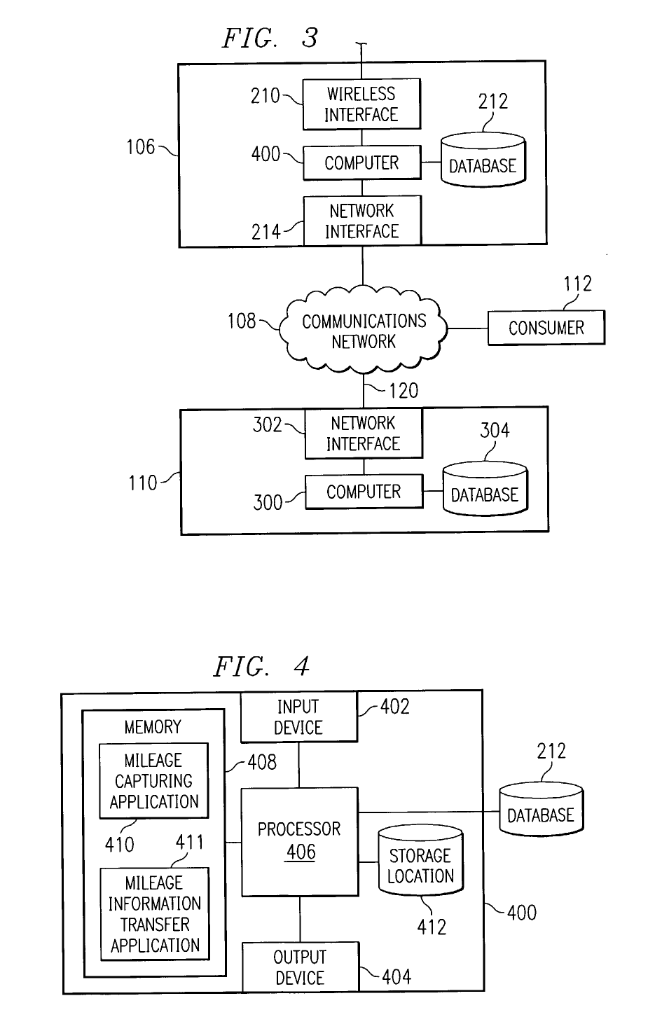

Central repository 106 represents any suitable location remote from vehicle 102 that includes suitable functionality to transmit and receive information to and from vehicle 102 via wireless network 104. Details regarding central repository 106 are described more fully below in conjunction with FIG. 2. Generally, central repository 106 includes any suitable hardware, firmware, and/or software located at an information technology services company that communicates with vehicle 102 to obtain vehicle mileage information and store that information for later use. Central repository 106 may be an entity other than an information technology services company, such as a business or government entity (i.e., where central repository 106 and entity 110 are one and the same). Central repository 106, as described more fully below in conjunction with FIG. 3, may also include suitable functionality to transmit vehicle mileage information to entities 110 and/or consumer 112 via communications network 108.

Communications network 108 may be any suitable wireline or wireless communications network, or combination of wireline or wireless communications networks, that facilitate communication of information between remote endpoints. As one example, communications network 108 may be a global computing network, such as the Internet. Communications network 108 may be coupled to central repository 106, entities 110, and consumer 112 via any suitable communication links 120. Communication links 120 may be any suitable wireline or wireless links, such as twisted pair, coaxial cable, fiber optic, radio frequency, microwave, or other suitable links.

Entities 110 are any suitable entities that may have a desire to utilize mileage information for a particular vehicle 102. For example, a business 110a may desire to utilize the mileage information to bill clients for any number of reasons, such as for insurance premiums, leasing of automobiles, or other suitable purposes. A government 110b may desire to utilize the mileage information to bill entities for such things as road use tax or to bill citizens for such things as vehicle registration. A manufacturer 110c may desire to utilize mileage information for communicating with owners of their automobiles. For example, manufacturer 110c may wish to send owners warranty information or maintenance reminders. Consumer 112 may be any suitable consumer or entity that receives mileage information regarding their particular vehicle. For example, consumer 112 may receive bills from entities 110 or directly from central repository 106. Or, consumers 112 may receive vehicle mileage reports from entities 110 and/or central repository 106.

Now that system 100 has been generally described, FIGS. 2 through 4 describe one or more embodiments of system 100 in more detail, including some of the devices, elements, hardware and/or software that is utilized to carry out their respective functions.

FIG. 2 is a block diagram illustrating the capturing and storing of vehicle mileage from vehicle 102 in accordance with one embodiment of system 100. More specifically, FIG. 2 illustrates vehicle 102 and central repository 106 in block diagram form with wireless network 104 disposed therebetween.

Referring to the block diagram of vehicle 102, vehicle 102 includes, in one embodiment, an electrical system 200, an odometer 202, and a computer 204 all coupled to one another via an electrical bus 206. Vehicle 102 also includes a wireless interface 208 coupled to computer 204.

Electrical system 200 is any suitable electrical system within vehicle 102 that functions to control various systems within vehicle 102. For example, electrical system 200 may have the ability to control the engine, brake system, transmission, exhaust system, or any other suitable system within vehicle 102. Electrical system 200 may have its own logic therein or may use logic that is associated with computer 204. In the former case, electrical system 200 may have any suitable number of microprocessors, application specific integrated circuits (“ASICs”), digital signal processors (“DSPs”), or any other types of logical devices for controlling and/or monitoring a system of vehicle 102. In the latter case, electrical system 200 may exchange with computer 204 a variety of messages, represented by electrical signals, over electrical bus 206.

Odometer 202 is any suitable device coupled to vehicle 102 that functions to keep track of how many miles vehicle 102 traverses. Odometer 202 may represent an odometer of vehicle 102 that captures the total vehicle mileage starting from zero, or odometer 202 may represent a trip meter of vehicle 102 that captures the vehicle mileage traversed during a particular period of time. Vehicle mileage may be stored in nonvolatile memory in vehicle 102 so that the mileage reading is not lost if the battery of vehicle 102 goes dead. This nonvolatile memory may be located in any suitable location within vehicle 102, such as computer 204. Odometer 202 communicates with computer 204 via electrical bus 206.

Electrical bus 206 may be any suitable bus, such as a controller area network bus, a J1939 bus, or any other suitable collection of wires, fiber optic cables, or wireless channels that are able to relay messages between electrical system 200, odometer 202, and computer 204. Any suitable protocol may be used to transfer signals over electrical bus 206, such as J1708.

Computer 204 is any suitable logical device that is operable to read mileage readings from odometer 202 and initiate transmission of mileage readings to central repository 106 via wireless network 104. An example of computer 204 is the logic associated with the OnStar® telematics system that is found in some of General Motors' vehicles. Computer 204 couples to electrical bus 206 for the purpose of receiving signals from odometer 202 that are representative of a mileage reading for vehicle 102. Computer 204 may have the ability to store this mileage information in a storage location until that information is needed. At the appropriate time as described further below, computer 204 initiates transmission of a mileage reading over wireless network 104 to central repository 106 with the help of wireless interface 208.

Wireless interface 208 is any suitable device that supports wireless communications between computer 204 of vehicle 102 and wireless communication devices associated with wireless network 104, such as base transceiver stations or wireless access points. For example, wireless interface 208 may be a transceiver, a wireless modem, or other suitable wireless interface. Wireless interface 208 is coupled to computer 204 in any suitable manner.

A signal indicative of a mileage reading for vehicle 102 for a respective time is transmitted to central repository 106 via wireless links 118 and wireless network 104, both of which have been described above in conjunction with FIG. 1.

Referring to the block diagram of central repository 106, the signal representing the mileage reading is received at central repository 106 by computer 400 via a wireless interface 210. Wireless interface 210 is any suitable device that supports wireless communications between computer 400 of central repository 106 and wireless communication devices associated with wireless network 104, such as base transceiver stations or wireless access points. For example, wireless interface 210 may be a transceiver, a wireless modem, or other suitable wireless interface. Because wireless interface 210 may be receiving multiple signals from multiple vehicles 102, wireless interface 210 is typically more powerful than wireless interface 208 of vehicle 102. A signal received by wireless interface 210 is transmitted to computer 400 for the purpose of storing in a database 212 for later use.

Computer 400, which is described in greater detail below in conjunction with FIG. 4, generally functions to query computer 204 of vehicle 102 over wireless network 104 and receive, in response to the query, a signal indicative of a mileage reading for vehicle 102 for a respective time. Computer 400 may then store this information, such as in database 212, until needed. Computer 400 may be any suitable computing device, such as a PC or server, that has the ability to execute logic. Although only one computer 400 is shown in FIG. 2, computer 400 may include any number of, or network of, computers.

Central repository 106 also includes, in this embodiment, a network interface 214 that functions to communicate with communications network 108 (FIG. 3). Network interface 214, in one embodiment, is a network interface card; however, network interface 214 may be other devices suitable for receiving and transmitting signals, such as a modem. Now that the interaction between vehicle 102 and central repository 106 has been described, interaction between central repository 106 and entities 110 or consumer 112 are described below in conjunction with FIG. 3.

FIG. 3 illustrates central repository 106 and entity 110 in block diagram form with communications network 108 disposed therebetween. FIG. 3 also illustrates consumer 112 coupled to communications network 108.

For a discussion of the block diagram of central repository 106, please refer to FIG. 2. As a continuation of the discussion of FIG. 2, network interface device 214 allows computer 400 to communicate with communications network 108 for the purpose of transmitting signals to either entity 110 or consumer 112. Central repository 106, entity 110, and consumer 112 are coupled to communications network 108 with any suitable communication link 120. Communications network 108, as described above in conjunction with FIG. 1, is any suitable communications network or combination of communication networks that are operable to convey information from one point to another point. Communications network 108 may include any number of devices (not explicitly shown), such as routers, gateways, switches, or any other suitable type of device that functions to transfer information from point to point.

Referring to the block diagram of entity 110, entity 110 receives information from central repository 106 over communications network 108 via a network interface 302. Network interface 302, in one embodiment, is a network interface card; however, network interface 302 may be other devices suitable for receiving signals, such as a modem. Network interface 302 is adapted to couple to communication network 108 via communication link 120 and is operable to receive and transmit signals. Network interface device 302 transmits the received signals to a computer 300 associated with entity 110.

Computer 300 may be any suitable computing device, such as a personal computer or server, that functions to receive information and store the information in a database 304 for later use. Database 304 may be any suitable storage location associated with computer 300 for the purpose of storing information related to mileage information for vehicle 102. Computer 300 may include any suitable hardware, firmware, and/or software that allows entity 110 to bill consumer 112 for services rendered. For example, if entity 110 is an insurance company, then computer 300 may have the ability to generate bills based on the mileage information for vehicle 102 stored in database 304 and to send consumer 112 a bill on a monthly basis. Other examples of uses of mileage information by entity 110 are described below.

Consumer 112 represents any suitable consumer that is associated with vehicle 102. Typically, consumer 112 is the responsible party for paying any bills or other fees associated with vehicle 102 based on the mileage traveled by vehicle 102. For example, if consumer 112 owns vehicle 102 and has contracted with entity 110 for auto insurance, then consumer 112 may be billed by entity 110 based on the mileage driven by vehicle 102. Entity 110 may electronically send the bill to consumer 112 over communications network 108. To send a bill or other report electronically over communications network 108, consumer 112 would have to have a suitable computer with e-mail software and a suitable network interface, such as those described above. Consumer 112 may also receive bills and/or reports via regular mail.

Consumer 112 may also receive information directly from central repository 106 in other embodiments. In those embodiments, computer 400 of central repository 106 would have logic that is operable to transmit mileage information to consumer 112 over communications network 108 via network interface 214 and communication links 120. Mileage information sent to consumer 112 may be retrieved from database 212. Further details of computer 400 are described below in conjunction with FIG. 4.

FIG. 4 is a block diagram of computer 400 for use in carrying out one or more embodiments of system 100. As illustrated in FIG. 4, computer 400 includes an input device 402, an output device 404, a processor 406, a memory 408 storing mileage capturing application 410 and mileage information transfer application 411, and a storage location 412. Also illustrated in FIG. 4 is database 212 coupled to computer 400.

Input device 402 is coupled to computer 400 for the purpose of inputting information, such as information related to vehicle 102. In one embodiment, input device 402 is a keyboard; however, input device 402 may take other suitable forms, such as a mouse or a stylus. Output device 404 may be any suitable visual display unit, such as a liquid crystal display (“LCD”) or cathode ray tube (“CRT”) display. Output device 404 may also be coupled to a printer (not shown) for the purpose of printing out any desired information, such as information related to vehicle 102.

Processor 406 comprises any suitable type of processing unit that executes logic. One of the functions of processor 406 is to retrieve mileage capturing application 410 from memory 408 and execute mileage capturing application 410 to obtain mileage information from vehicle 102, as described more fully below. Processor 406 may also control the storing and retrieving of information in database 212 or storage location 412 of computer 400. Such information may include mileage information related to a particular vehicle 102 for information on a particular entity 110.

Mileage capturing application 410 is a computer program written in any suitable computer language that is operable, in one embodiment, to query computer 204 of vehicle 102 over wireless network 104, receive a signal from computer 204 in response to the query that it is indicative of a mileage reading for vehicle 102 for a respective time, and store the mileage reading in database 212. In the illustrated embodiment, mileage capturing application 410 is logic encoded in memory 408. However, in alternative embodiments, mileage capturing application 410 is implemented through application specific integrated circuits (“ASICs”), field programmable gate arrays (“FPGAs”), digital signal processors (“DSPs”), or other suitable specific or general purpose processors.

Mileage information transfer application 411 is a computer program written in any suitable computer language that is operable, in one embodiment, to send mileage information for a particular vehicle 102 to a particular entity 110 or a particular consumer 112. Mileage information transfer application 411 may send this mileage information on a periodic basis or an as-needed basis, depending on the agreement between entity 110 and the owners of central repository 106. In the illustrated embodiment, mileage information transfer application 411 is logic encoded in memory 408. However, in alternative embodiments, mileage information transfer application 411 is implemented through ASICs, FPGAs, DSPs, or other suitable specific or general purpose processors.

Memory 408 and storage location 412 may comprise files, stacks, databases, or other suitable organizations of volatile or non-volatile memory. Memory 408 and storage location 412 may be random access memory, read only memory, CD-ROM, removable memory devices, or any other suitable devices that allow storage and/or retrieval of data. Memory 408 and storage location 412 are interchangeable and may perform the same function.

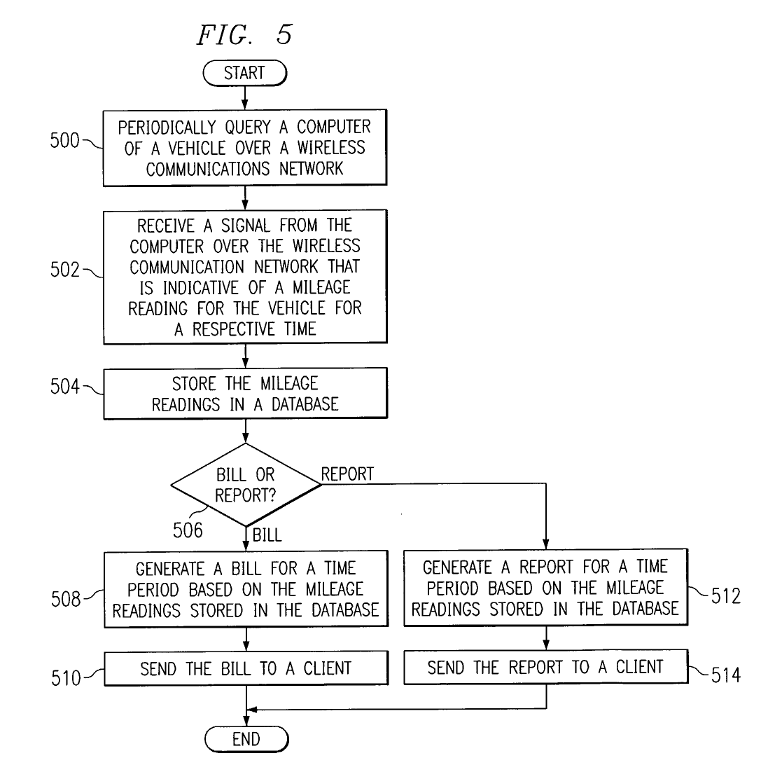

FIG. 5 is a flowchart illustrating a method of capturing, storing, and utilizing vehicle mileage information in accordance with one embodiment of the present invention. FIG. 5 illustrates some of the functionality of mileage capturing application 410 and mileage information transfer application 411.

The method begins at step 500, where computer 204 of vehicle 102 is periodically queried by computer 400 over wireless network 104. For example, computer 204 may be queried on a monthly basis to determine how many miles vehicle 102 has traveled in a one month period. In response to each query by computer 400, a signal is received from computer 204, at step 502, over wireless network 104. Each signal is indicative of a mileage reading associated with odometer 202 of vehicle 102 for a respective time. In some embodiments, the signals are received periodically from computer 204 without queries from computer 400. Each received mileage reading is then stored, at step 504, in database 212 or other suitable location associated with computer 400. Any suitable storage software may be utilized to organize the information stored in database 212.

At decisional step 506, it is determined whether a bill or a report is required to be sent to either entity 110 or consumer 112. If a bill needs to be generated, then a bill is generated at step 508 for a particular time period based on the mileage reading stored in database 212. Thereafter, the bill is sent to entity 110 at step 510. In other embodiments, instead of a bill being sent to entity 110, an indication of an amount chargeable for used mileage of vehicle 102 is sent to entity 110 so that entity 110 may generate a bill. The amount chargeable is based, at least in part, on the stored mileage readings in database 212. As one example, if entity 110 is an insurance company, then they may contract with the owner of central repository 106 to have computer 400 automatically send them mileage information for a particular vehicle on a monthly basis. In this manner, the insurance company can bill the owner of the vehicle based on the number of miles that were driven for that month. Because the mileage information from a particular vehicle is obtained without any interaction from either the owner or driver of vehicle 102, then the insurance company may be assured that accurate mileage readings have been recorded and, therefore, an accurate billing may be accomplished. In a particular embodiment, instead of having computer 400 automatically send mileage information for a particular vehicle, computer 400 may function to grant a permission to user associated with entity 110 so that the user may access database 212 for the purpose of retrieving the desired mileage information.

Referring back to decisional step 506, if a report is required to be generated, then a report is generated, at step 512, for a time period based on the mileage readings of a particular vehicle stored in database 212. Thereafter, the report may be sent to a client, such as entity 110 or consumer 112, as denoted by step 514. For example, a report may represent the warranty information for vehicle 102 that needs to be sent to consumer 112 to let them know information about the warranty of that particular vehicle. Or the report may represent maintenance information for vehicle 102, such as maintenance reminders to consumer 112.

A method for remotely managing mileage information for a particular vehicle is described above. Once central repository 106 captures mileage information for a particular vehicle, then this information may be stored and utilized for many different purposes. One of the purposes described above is for billing owners of vehicles. For example, a bill may represent fees associated with various uses associated with the vehicle on a per-mile basis. As examples, such uses may be insurance for the vehicle, leasing or renting the vehicle, registering the vehicle, taxing the vehicle for such things as road use, or travel expenses that need to be billed to a client. Another purpose described above is reports associated with the mileage information for vehicle 102. The reports may represent warranty information or maintenance reminders for the vehicle. In addition, the mileage information may be used to prevent fraud in, for example, the sale of vehicle 102. In other words, the owner of a vehicle would not be able to “jimmy” the odometer reading to make it seem that the vehicle has less miles than it actually does. With the availability of wireline and wireless communication networks nowadays, the mileage information for a particular vehicle 102 may be captured and utilized in an accurate and cost-effective manner.

Although embodiments of the invention and their advantages are described in detail, a person skilled in the art could make various alterations, additions, and omissions without departing from the spirit and scope of the present invention as defined by the appended claims.

What is claimed is:

1. A method, comprising:
receiving a signal from a computer on a vehicle over a wireless communications network, the signal indicative of a mileage reading for the vehicle; and
storing the mileage reading.

2. The method of claim 1, further comprising repeating the receiving and storing steps.

3. The method of claim 1, wherein the mileage reading is indicative of an odometer reading of the vehicle.

4. The method of claim 1, wherein the mileage reading is indicative of a trip meter reading of the vehicle.

5. The method of claim 1, further comprising generating an indication of an amount chargeable for used mileage of the vehicle based, at least in part, on the stored mileage reading.

6. The method of claim 5, further comprising sending the indication of the amount chargeable to a client.

7. The method of claim 5, wherein the indication of the amount chargeable represents fees associated with insurance for the vehicle on a per-mile basis.

8. The method of claim 5, wherein the indication of the amount chargeable represents fees associated with leasing the vehicle on a per-mile basis.

9. The method of claim 5, wherein the indication of the amount chargeable represents fees associated with renting the vehicle on a per-mile basis.

10. The method of claim 5, wherein the indication of the amount chargeable represents fees associated with registration of the vehicle on a per-mile basis.

11. The method of claim 5, wherein the indication of the amount chargeable represents fees associated with a road use tax for the vehicle on a per-mile basis.

12. The method of claim 5, wherein the indication of the amount chargeable represents fees associated with travel expenses for the vehicle on a per-mile basis.

13. The method of claim 1, further comprising generating a report for a time period, the report based, at least in part, on the stored mileage reading.

14. The method of claim 13, wherein the report represents warranty information for the vehicle.

15. The method of claim 13, wherein the report represents maintenance information for the vehicle.

16. The method of claim 1, wherein the wireless communications network comprises a cellular telephone network.

17. The method of claim 1, wherein the wireless communications network comprises a satellite-based network.

18. The method of claim 1, further comprising sending mileage information for the vehicle to a client, the mileage information related to the stored mileage reading.

19. The method of claim 18, wherein sending comprises transmitting electronically over a communications network.

20. The method of claim 18, wherein sending comprises mailing.

21. The method of claim 18, wherein sending mileage information for the vehicle to the client comprises granting the client a permission to access a database.

22. Logic encoded in media for remotely managing vehicle mileage, the logic operable to perform the following steps:
receiving a signal from a computer on a vehicle over a wireless communications network, the signal indicative of a mileage reading for the vehicle for a respective time; and
storing the mileage reading.

23. The logic encoded in media of claim 22, wherein the logic is further operable to repeat the receive and store steps.

24. The logic encoded in media of claim 22, wherein the mileage reading is indicative of an odometer reading of the vehicle.

25. The logic encoded in media of claim 22, wherein the mileage reading is indicative of a trip meter reading of the vehicle.

26. The logic encoded in media of claim 22, wherein the logic is further operable to generate an indication of an amount chargeable for used mileage of the vehicle based, at least in part, on the stored mileage reading.

27. The logic encoded in media of claim 26, wherein the logic is further operable to send the indication of the amount chargeable to a client.

28. The logic encoded in media of claim 26, wherein the indication of the amount chargeable represents fees associated with insurance for the vehicle on a per-mile basis.

29. The logic encoded in media of claim 26, wherein the indication of the amount chargeable represents fees associated with leasing the vehicle on a per-mile basis.

30. The logic encoded in media of claim 26, wherein the indication of the amount chargeable represents fees associated with renting the vehicle on a per-mile basis.

31. The logic encoded in media of claim 26, wherein the indication of the amount chargeable represents fees associated with registration of the vehicle on a per-mile basis.

32. The logic encoded in media of claim 26, wherein the indication of the amount chargeable represents fees associated with a road use tax for the vehicle on a per-mile basis.

33. The logic encoded in media of claim 26, wherein the indication of the amount chargeable represents fees associated with travel expenses for the vehicle on a per-mile basis.

34. The logic encoded in media of claim 22, wherein the logic is further operable to generate a report for a time period, the report based, at least in part, on the stored mileage reading.

35. The logic encoded in media of claim 34, wherein the report represents warranty information for the vehicle.

36. The logic encoded in media of claim 34, wherein the report represents maintenance information for the vehicle.

37. The logic encoded in media of claim 22, wherein the wireless communications network comprises a cellular telephone network.

38. The logic encoded in media of claim 22, wherein the wireless communications network comprises a satellite-based network.

39. The logic encoded in media of claim 22, wherein the logic is further operable to electronically transmit mileage information for the vehicle to a client, the mileage information related to the stored mileage reading.

40. The logic encoded in media of claim 39, wherein the logic is further operable to grant the client a permission to access a database storing the mileage information.

41. A method, comprising:
periodically receiving a signal from a computer on a vehicle over a wireless communications network, each received signal indicative of a mileage reading for the vehicle for a respective time, the mileage reading selected from the group consisting of an odometer reading and a trip meter reading;
storing each mileage reading; and
generating mileage information related to the stored mileage readings.

42. The method of claim 41, further comprising sending the mileage information to a client.

43. The method of claim 41, wherein the mileage information comprises an indication of an amount chargeable for used mileage of the vehicle.

44. The method of claim 43, further comprising sending the indication of the amount chargeable to a client.

45. The method of claim 43, wherein the indication of the amount chargeable represents fees associated with insurance for the vehicle on a per-mile basis.

46. The method of claim 43, wherein the indication of the amount chargeable represents fees associated with leasing the vehicle on a per-mile basis.

47. The method of claim 43, wherein the indication of the amount chargeable represents fees associated with renting the vehicle on a per-mile basis.

48. The method of claim 43, wherein the indication of the amount chargeable represents fees associated with registration of the vehicle on a per-mile basis.

49. The method of claim 43, wherein the indication of the amount chargeable represents fees associated with a road use tax for the vehicle on a per-mile basis.

50. The method of claim 43, wherein the indication of the amount chargeable represents fees associated with travel expenses for the vehicle on a per-mile basis.

51. A method, comprising:
sensing a signal by an electrical bus of a vehicle that is indicative of a mileage reading for the vehicle;
storing the signal; and
sending the signal to a computer remote from the vehicle over a wireless communications network for use in generating an indication of an amount chargeable for used mileage of the vehicle.

52. The method of claim 51, further comprising repeating the sensing, storing, and sending steps.

53. The method of claim 51, wherein the mileage reading is indicative of an odometer reading of the vehicle.

54. The method of claim 51, wherein the mileage reading is indicative of a trip meter reading of the vehicle.

55. The method of claim 51, wherein the indication of the amount chargeable represents fees associated with insurance for the vehicle on a per-mile basis.

56. The method of claim 51, wherein the indication of the amount chargeable represents fees associated with leasing the vehicle on a per-mile basis.

57. The method of claim 51, wherein the indication of the amount chargeable represents fees associated with renting the vehicle on a per-mile basis.

58. The method of claim 51, wherein the indication of the amount chargeable represents fees associated with registration of the vehicle on a per-mile basis.

59. The method of claim 51, wherein the indication of the amount chargeable represents fees associated with a road use tax for the vehicle on a per-mile basis.

60. The method of claim 51, wherein the indication of the amount chargeable represents fees associated with travel expenses for the vehicle on a per-mile basis.

61. The method of claim 51, wherein the wireless communications network comprises a cellular telephone network.

62. The method of claim 51, wherein the wireless communications network comprises a satellite-based network.

63. The method of claim 51, further comprising receiving, before the sending step, a query from the computer remote from the vehicle, the query representing a request for the mileage reading of the vehicle for a desired time.
